(19) United States
(12) Patent Application Publication
(10) Pub. No.: US 2017/0242415 A1
(43) Pub. Date: Aug. 24, 2017

(54) SELF-REGULATING AND INSPECTING SORTING SYSTEM

(71) Applicant: ContMid Holdings, Inc., Park Forest, IL (US)

(72) Inventors: Phil C. Johnson, Naperville, IL (US); Darren DeMill, Joliet, IL (US)

(21) Appl. No.: 15/425,320

(22) Filed: Feb. 6, 2017

Related U.S. Application Data
(60) Provisional application No. 62/291,981, filed on Feb. 5, 2016.

(51) Int. Cl. G05B 19/048; G01N 21/95; G05B 19/18

(52) U.S. Cl. CPC G05B 19/048; G05B 19/186; G01N 21/95; G05B 2219/24015; G05B 2219/50252; G05B 2219/49298

(57) ABSTRACT

A production system and method may comprise a first production processing machine capable of processing a workpiece and a second production processing machine capable of processing the workpiece. The production system and method may also comprise a workpiece transfer device, the workpiece transfer device moving the workpiece from the first production processing machine to the second production processing machine, an inspection device identifying whether the workpiece meets at least one specification of the workpiece, and a computing device in communication with the inspection device notifying a user whether the workpiece is compliant with the at least one specification where the computing device is operative communication with either or both of the first production processing machine and the second production processing machine whereby the computing device alters operation of either or both of the first and second production processing machines.

### CROSS-REFERENCE TO RELATED APPLICATION

This application claims benefit from U.S. Provisional Patent Application No. 62/291,981, entitled “Sorting System,” filed on Feb. 5, 2016, which is hereby incorporated in its entirety by reference.

### FIELD OF THE INVENTION

The present invention relates to a workpiece sorting system and more particularly to an automated machine performing workpiece sorting, dimensional inspection, defect inspection, and self-regulating quality control of defect and/or manufacturing process machine based on the inspections of workpieces, such as fasteners.

### BACKGROUND

With increasing competition in manufacturing, reducing production costs while maintaining, if not improving, quality of the manufactured workpiece is important. When the workpiece is manufactured in large quantities, unique challenges in the manufacturing process are presented. For example, the manufacturing of a fastener as the workpiece requires dimensional inspection of each fastener, which may not be visible to the naked eye. Moreover, to accomplish inspection, the fasteners must be arranged in an orderly fashion. Fasteners that do not meet pre-established quality guidelines must also be segregated from the remaining fasteners that are ultimately counted and delivered to the customer and/or used in further assembly in the same manufacturing facility.

Within a manufacturing process line operation, manual operator arrangement of thousands, if not millions, of fasteners is cost-prohibitive and impractical. Likewise, manual inspection of many different types of fasteners may lead to operator error, may not be possible due to sight limitations of the naked eye, or simply may not be possible due to the speed in which the fasteners pass along the fabrication process—it is not likely feasible.

Furthermore, the present use of machines is limited by time required for human instruction, re-tooling, cleaning, re-calibrating, etc. These human interactions can require complete line shut down and startup—reducing efficiency, creating scrap, and increasing costs during these lengthy downtimes. Further, it can be difficult to determine if and/or when tooling or other parts of the production process are breaking down or wearing out. In most circumstances, this is not determined until the workpieces are out of tolerance.

Moreover, communication between a central processor and the machine tooling is limited. This lack of communication makes it difficult to determine or predict when tooling may need to be replaced, adjusted or fixed until the workpieces are out of tolerance. This can further cause delay in the manufacturing process. Further still, this lack of communication can make it difficult for needed adjustments, modifications or updates to the manufacturing process or machinery to be made until the workpieces end up being out of tolerance. This can result in significant scrap or rework of the workpieces and/or downtime of the process.

Therefore, there exists a need for an improved workpiece sorting and inspection system that can efficiently and effectively sort, inspect and segregate workpieces; require little human intervention, interaction and instruction; and can communicate effectively between the various components thereof.

### SUMMARY OF THE INVENTION

The present technology is directed to a workpiece sorting system, used to sort, inspect, and segregate workpieces. In particular, the present technology is directed to the sorting system for analyzing workpieces to determine if they meet pre-established guidelines for conformity. The present technology allows for better control of the manufacturing process as the system and its feedback loops may control the production equipment and allow for adjustments to production machines, cleaning of the production machines, recalibrating of the production machines, instructing the shut down and/or start-up of machines, providing feedback to engineers or supervisors as to product dimensions and specifications, along with various other benefits.

As such, the sorting system described herein is configured to analyze one or more workpieces to determine if they meet pre-established guidelines for conformity, the sorting system comprising: at least one vision camera; at least one feeding unit configured to orient the one or more workpieces into at least one conveyor unit; the at least one conveyor unit configured to transfer the one or more workpieces from the at least one feeding unit onto one or more inspection units; a first inspection unit operatively coupled with the at least one vision camera, the first inspection unit including a measurement unit, wherein the measurement unit inspect a dimensional conformity of the one or more workpieces, the first inspection unit generates a first image; a second inspection unit configured to identify a defect conformity and to generate a second image; at least one operation unit configured to execute one or more pre-established operations onto the one or more workpieces, the at least one operation unit employs at least one operation in response to the one or more inspection units; a memory to store instructions; and a processor, communicatively coupled to the memory that facilitates execution of the instructions to perform operations.

A production system and method may comprise a first production processing machine capable of processing a workpiece and a second production processing machine capable of processing the workpiece. The production system and method may also comprise a workpiece transfer device, the workpiece transfer device moving the workpiece from the first production processing machine to the second production processing machine, an inspection device identifying whether the workpiece meets at least one specification of the workpiece, and a computing device in communication with the inspection device notifying a user whether the workpiece is compliant with the at least one specification where the computing device is operative communication with either or both of the first production processing machine and the second production processing machine whereby the computing device alters operation of either or both of the first and second production processing machines.

In the production method and system, the inspection device may include at least one vision camera in communication with the computing device.

In the production method and system the workpiece transfer device may include at least one feeding unit, and at least one conveyor unit where the at least one feeding unit orients the workpiece into the at least one conveyor unit.

In the production method and system the at least one conveyor unit may transfer the workpiece from the at least one feeding unit onto the inspection device.

In the production method and system, the inspection device may include a measurement unit device, where the measurement unit inspects a dimensional conformity of the workpiece.

In the production method and system, the inspection device may include at least one selected from the group consisting of a laser-timing sensor, an eddy current testing probe, a pulsed eddy current, and an eddy current array.

In the production method and system, the computing device may be remote from the first and second production processing machines.

In the production method and system, the computing device may be in wireless communication with the first and second production processing machines and the inspection device.

In the production method and system the inspection device may include a sensor determining required parameters selected from the group consisting of presence, dimensions of recesses, head size, thread dimensions, width, and height.

In the production method and system, the workpiece transfer device comprises a removal mechanism selected from the group consisting of magnet, a flipper, a vacuum, and air knife.

In the production method and system, the workpiece transfer device may include a pneumatic line with a solenoid.

In the production method and system, the computing device may alter operation of either or both of the first and second production processing machines by altering at least one tool of either of the first and second production processing machines.

In the production method and system altering the at least one tool may include at least one of replacing the at least one tool with a second tool, modifying an operation process of the at least one tool, and modifying the at least one tool.

In the production method and system, the computing device generates date from the inspection device, where the data comprises statistical process control (SPC), productivity, Overall Equipment Effectiveness (OEE), and machine setup recipes for quick change.

In the production method and system, the first production processing machine is different from the second production processing machine.

In the production method and system, the workpiece transfer device moves the workpiece from the first or second production processing machine to the inspection device.

In the production method and system the workpiece transfer device may be in communication with the computing device to remove the workpiece from the workpiece transfer device when the workpiece fails to meet the at least one specification.

A computer-implemented method of analyzing workpieces to determine if they meet pre-established guidelines for conformity may include identifying one or more conformity requirements of one or more inspection modules associated with a production system by a device operatively coupled to a processor, determining a pre-established guideline that satisfies the one or more conformity requirements by the device, and executing operation associated with the one or more workpieces that are not required by the pre-established guideline by the device. The method may also include analyzing data associated with the operation associated with the one or more workpieces, and executing one or more actions based on the analysis of the operation associated with the one or more workpieces.

The computer-implemented method may include updating the pre-established guideline based on changes in the one or more conformity requirements by the device.

In the computer-implemented method the executing one or more actions may include modifying at least one tool of the production system.

A high-speed production system may include first and second production processing machines applying a specified production task on a workpiece, and a workpiece transfer device, the workpiece transfer device transferring the workpiece from the first production processing machine to the second production processing machine. The high-speed production system may also include an inspection device identifying whether the workpiece meets at least one specification, and a computing device in operative communication with the inspection device notifying a user whether the workpiece is compliant with the at least one specification, where the computing device is in operative communication with the inspection device and the first and second production processing machines whereby the computing device alters operation of either or both of the first and second production processing machines.

In the high-speed production system, the computing device may be a communication link between all of the inspection device and the first and second production processing machines.

In the high-speed production system, operation the inspection device may adjust operation of the first and second production processing machines through the communication link.

In the high-speed production system, the workpiece may include a fastener.

A production process may include identifying one or more conformity requirements of one or more inspection modules associated with a production system, determining a pre-established guideline that satisfies the one or more conformity requirements, and executing operation associated with one or more workpieces that are not required by the pre-established guideline. The method may also include analyzing data associated with the operation associated with the one or more workpieces, and executing one or more actions based on the analysis of the operation associated with the one or more workpieces.

Specific reference is made to the appended claims, drawings, and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### BRIEF DESCRIPTION OF THE DRAWINGS

The present teachings may be better understood by reference to the following detailed description taken in connection with the following illustrations, wherein:

FIG. 1A is an example, non-limiting, fastener as workpieces for the present system in accordance with various described embodiments;

FIG. 1B is an alternative embodiment of an example, non-limiting, nut as workpieces for the present system in accordance with various described embodiments;

FIG. 2 is a schematic view of the sorting/inspecting system in accordance with various described embodiments;

FIG. 3 is a perspective view of an exemplary feeder bowl in accordance with various described embodiments;

FIG. 4 is a perspective view of an exemplary feed rail in accordance with various described embodiments;

FIG. 5 is a perspective view of an exemplary vision camera and a vision illuminator in accordance with various described embodiments;

FIG. 6A is a perspective view of an exemplary system monitoring, controlling, and adjusting manufacturing process in accordance with various described embodiments;

FIG. 6B is a perspective view of exemplary system adjusting manufacturing process in accordance with various described embodiments;

FIG. 6C is a perspective view of an exemplary system adjusting conveyor belt process in accordance with various described embodiments;

FIG. 7 is a perspective view of a laser distance sensor in accordance with various described embodiments;

FIG. 8 is a perspective view of a laser timing sensor in accordance with various described embodiments;

FIG. 9 is a perspective view of a pneumatic line in accordance with various described embodiments;

FIG. 10 is a perspective view of a control panel in accordance with various described embodiments; and

FIG. 11 is a flow diagram of an example, non-limiting computer-implemented method.

FIG. 12 is a flow diagram of a communication link of the present system.

### DETAILED DISCLOSURE OF THE INVENTION

Reference will now be made in detail to exemplary embodiments of the present disclosure, examples of which are illustrated in the accompanying drawings. It is to be understood that other embodiments may be utilized and structural and functional changes may be made, including, without limitation the combination or elimination of the various features of the embodiments disclosed to encompass additional embodiments, without departing from the respective scope of the disclosure. Moreover, features of the various embodiments may be combined or altered without departing from the scope of the present disclosure. As such, the following description is presented by way of illustration only and should not limit in any way the various alternatives and modifications that may be made to the illustrated embodiments and still be within the spirit and scope of the present disclosure. The components of each embodiment may be utilized with any of the other embodiments—any combination is contemplated by this disclosure. However, for the sake of brevity not every possible combination of features is disclosed, but is contemplated hereby.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It is noted that the various embodiments described herein may include other components and/or functionality. It is further noted that while various embodiments refer to a sorting and inspection system, manufacturing and sorting system, manufacturing, inspection and sorting system, various other systems may be utilized in view of embodiments described herein. Further, the present system may include a variety of components, not limited to the components discussed below. Optionally, the present system may include multiple units of the same components. In an embodiment, the present system may include just an inspection station, a combination of an inspection and manufacturing system, or a sorting, inspection and manufacturing system. Further, the present system may include components of each of the inspection, manufacturing and sorting system to create a combination of each feature of the various systems.

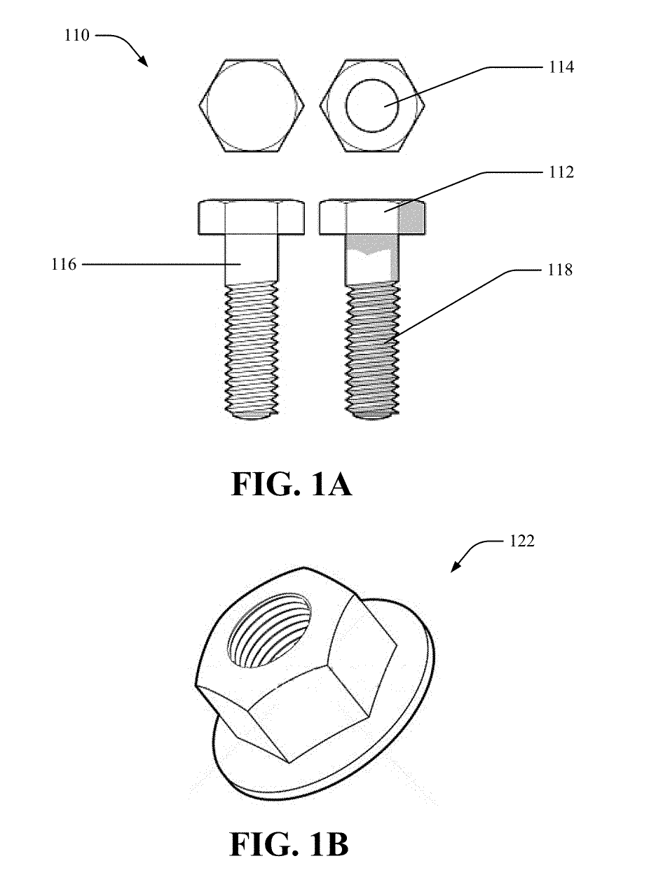

The present disclosure provides a system and a process for manufacturing, sorting and inspecting workpieces. The workpieces may be manufactured or naturally-occurring. Here, the workpiece referenced may be a cold-form product, e.g., a mechanical fastener. By ways of a non-limiting example, the workpiece may comprise a fastener 110 such as that shown in FIG. 1A. The fastener 110 may include a head 112. The head 112 may include a tool engagement portion 114, such as a Phillips style head or a flat head. The fastener 110 may further include a body 116 extending below the head 112. The body 116 may include threads 118 of any appropriate configuration. While the fastener 110 is shown and described herein, the present disclosure may include any kind of workpieces. However, for the sake of brevity the fastener 110 will be utilized in the description of the present system. For example, the workpiece may be any appropriate item, including, but not limited to nuts 122 such as that shown in FIG. 1B, bolts, nails, engagement devices utilized in the automotive industry (or other industries), etc. By way of a further non-limiting example, workpieces may include fasteners, screws, wiring, metal pieces, clips, plastic components, rubber components, electrical components, or any type of workpiece. Further, the workpiece may be comprised of any appropriate material, including, by way of a non-limiting example, metal, plastic, rubber, wood or a combination of such. The workpieces may all be the same type of item or they may be a combination of various different items, such as different sizes, different shapes, and/or different materials. The present system is particularly useful with workpieces manufactured in a high velocity manner. However, the present disclosure may apply to any workpieces and the present disclosure is not intended to be limited to any workpieces.

The present disclosure also provides a system allowing for improved control of a process for manufacturing and/or sorting workpieces, e.g. sorting compliant (those meeting its specifications) from non-compliant workpieces (those not meeting all of their specifications). The present disclosure is particularly useful for workpieces manufactured in a high-speed environment. For example, the present disclosure is particularly useful in those manufacturing settings where a million or more workpieces are created each day. Of course, however, the present disclosure is not limited to only a high-speed manufacturing system. It may also be utilized in other manufacturing arrangements.

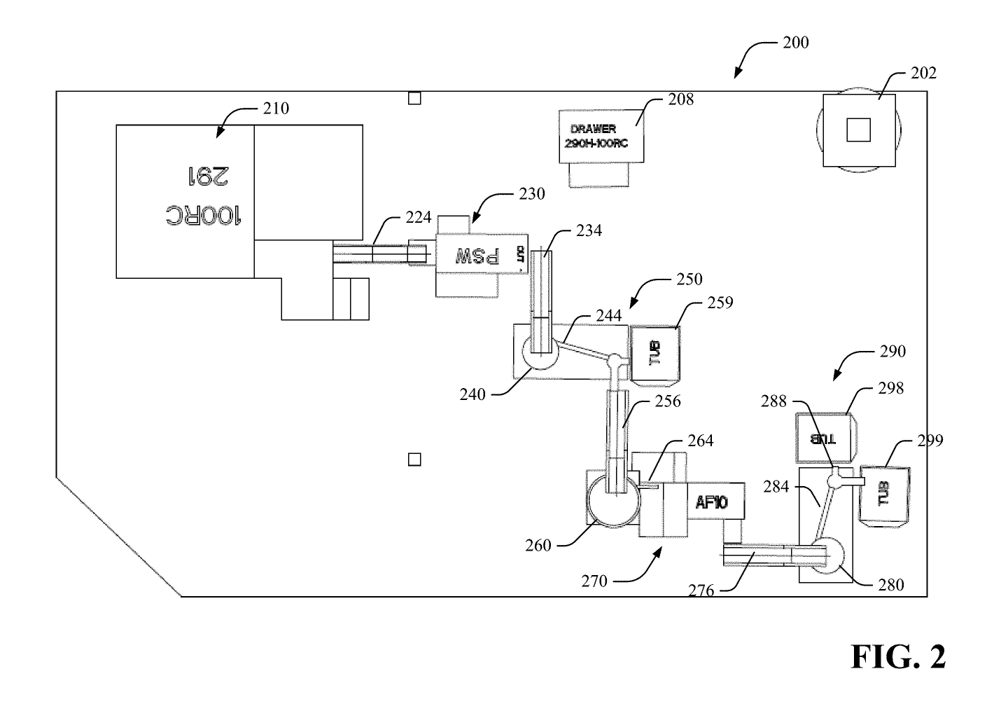

Referring to FIGS. 2-11, an embodiment of a sorting/manufacturing system 200 of workpieces 100 is shown. It should be understood, however, that this is merely an exemplary embodiment and that the present system may apply to any manufacturing process, including, without limitation, one including a machining process, molding, casting, forging or any other type of processing as part of it. For the sake of brevity of the present disclosure, not every example is included, but the present application contemplates any appropriate such production/manufacturing process. The sorting/manufacturing system 200 may be composed of several components that produce and inspect then segregate out non-conforming workpieces 100 from conforming workpieces that meet pre-established manufacturing guidelines or specifications. This system and method may help maintain the quality of the workpieces 100 produced, which is ultimately sent to the customer and/or used in further manufacturing process.

The workpieces 100 may be fasteners or any other appropriate component as noted above. The fasteners may include, for example, bolts or screws that generally have flat and enlarged head portions and unitary narrow, threaded or unthreaded portions. In general, once a batch of fasteners is manufactured, the fasteners within the batch are sorted so that non-conforming fasteners 110 can be removed from the batch and discarded, recycled or reworked. In this way, only the conforming, properly formed fasteners are ultimately made available for use in further manufacturing or sale to the public. This system is particularly useful with fasteners utilized in the automobile industry but is not limited to such industry. The system may also be used in a variety of fields, including plastics and metal pieces, stamping, forging, casting, molding, or any combination of the foregoing. The fasteners 110 are described for the sake of brevity herein.

The uninspected fasteners may be manufactured by any appropriate method—the present disclosure is not limited to the disclosed manufacturing process. The disclosed manufacturing process is disclosed as an exemplary embodiment and not intended to be a limiting disclosure. The present teachings can apply to any manufacturing process, e.g., high velocity manufacturing. While adjustments in the process will be made to account of the specific manufacturing process to which the present teachings are applied the fundamental teachings of the present disclosure can be applied to such manufacturing/production process.

In an embodiment shown in FIG. 2, the initial raw material may be provided to a wire turntable 202. The wire turntable 202 may be any appropriate machine capable of accepting raw material and positioning it for use in a manufacturing facility, e.g., a processing line. The raw material may be positioned to run the raw material from the wire turntable 202 into the wire drawer 208. The wire drawer 208 may be any appropriate machine capable of accepting raw material and feeding it into the next machine for use in a manufacturing facility, e.g., a process line. Please note that the wire drawer 208 identified above is an exemplary embodiment of a workpiece transfer device The raw material may then be fed from the wire drawer 208 into a first production processing machine, including, without limitation a primary operation unit 210 depicted in FIG. 2. The primary operation unit 210 may be one machine or multiple machines, e.g., a processing line. Here, the primary operation unit 210 processes unthreaded fasteners 120 from the raw material. This, however, is merely exemplary process that can be one or more machines/operations depending on the complexity of the part being manufactured and the equipment age and capability.

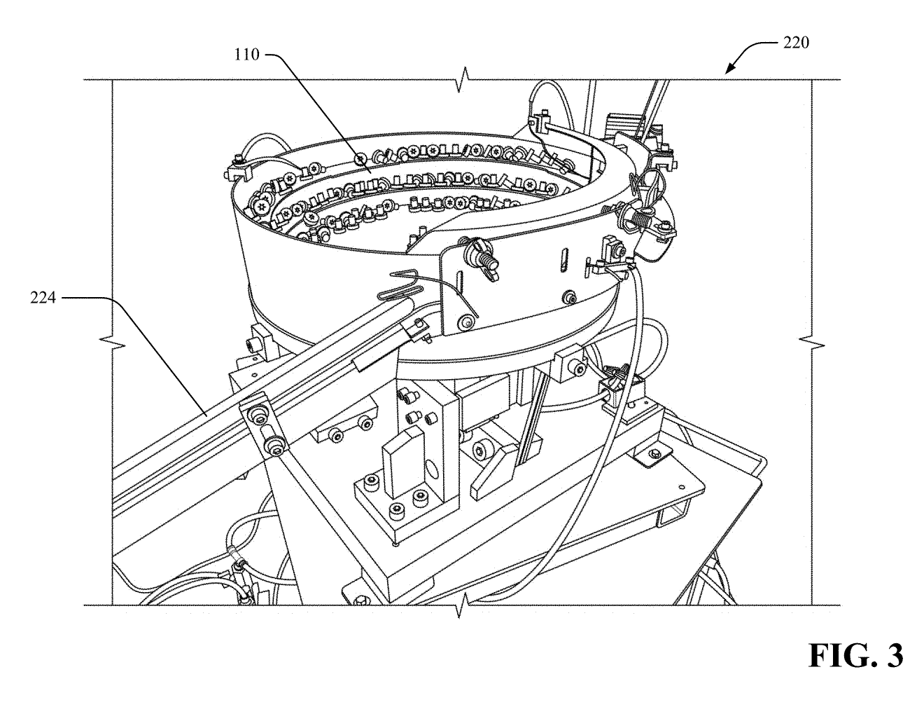

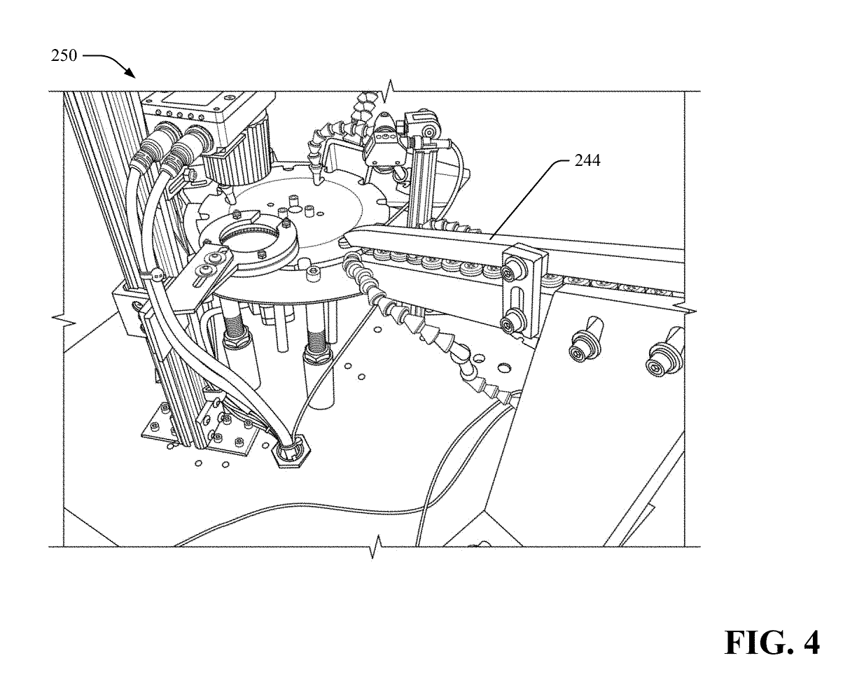

After being processed, the unthreaded fasteners 120 may be expelled from the primary operation unit 210 and fed into a parts washer 230 by way of a conveyor or a washer guide rail 224. The unthreaded fasteners 120 may be washed in the parts washer 230 and then expelled onto a workpiece transfer device, including, by way of a non-limiting example a primary conveyor guide rail 234 that delivers the unthreaded fasteners 120 into a primary feeder bowl 240, as shown in FIG. 3. The primary feeder bowl 240 may orientate and align each unthreaded fastener 120 from an initial irregular pile in a commonly-oriented fashion, feeding into a single line for transport on a primary feed rail 244. The primary feeder bowl 240 may orient the fasteners through any appropriate mechanism including shaking, magnetism, belts, centrifugal force, weight, shape, size, etc. Any appropriate method is contemplated hereby. The primary feed rail 244 transports unthreaded fasteners 120 from the primary feeder bowl 240 onto a primary inspection station 250, which may include any appropriate inspection device, as shown in FIG. 4. The guiderails 224, 234, 244 may be any appropriate type of workpiece transfer device, including, but not limited to a conveyer belt, a motorized staircase, a magnetized belt, rollers, etc.

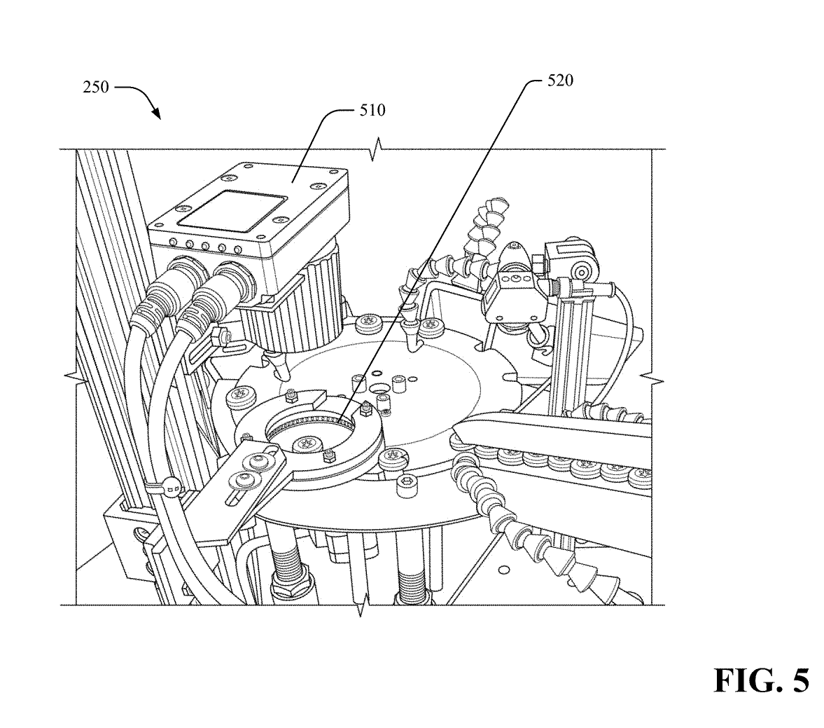

The primary inspection station 250 may include various inspection units including a vision camera 510, as shown in FIG. 5. By way of a further non-limiting example, the primary inspection station 250 may include a plurality of inspection units that may check any type of specification, e.g., dimensions, existence of defects, finish, pits, burrs, etc. The vision camera 510 may take images of the unthreaded fasteners 120 (or threaded fasteners) as they pass within a predetermined field of view. The vision camera 510 may be any appropriate camera, including a high-speed digital camera, an SLR camera, a DSLR camera, a video camera, etc. By way of a non-limiting example, the vision camera 510 may comprise a Cognex, model 5705. The vision camera 510 may include a GUI interface comprising spreadsheet and Easybuilder software downloaded on a computing device or devices that may be in operative communication with the vision camera 510. The computing device and vision camera 510 may be wireless or directly connected in any appropriate manner (e.g., direct wire, WI-FI, RFID, NFC, ZigBee, etc.). The minimum firmware requirements may include, for example In-Sight Explorer 5.1.0. The vision camera 510 may include the following job/program memory of 128 MB non-volatile flash memory and/or unlimited storage via remote network device, including, without limitation a computing device. The vision camera 510 may include image processing and memory of for example 512 MB SDRAM. The sensor type may include a ⅔-inch CCD, global shutter. The maximum resolution (pixels) may comprise about 2448×2048 and the frames per second of the vision camera 510 may be 16 full frames per second or 14 full frames per second. The vision camera 510 may include a lens type of c-mount and may include discrete inputs of one opto-isolated, acquisition trigger input. Additional inputs available may include a compatible I/O module and/or unlimited inputs when using an Ethernet I/O system. The discrete outputs may include two built-in, high-speed outputs. Additional outputs may be available such as a compatible I/O module and unlimited outputs when using an Ethernet I/O system. The vision camera 510 may further include the following specifications:
Status LEDs: Power, Network Status, Network Traffic, 2 user configurable
Network Communication: 1 Ethernet port, 10/100/1000 BaseT with auto MDIX. IEEE 802.3 TCP/IP protocol
Serial Communication: RS-232C
Ethernet Protocols: EtherNet/IP; PROFINET; Modbus/TCP; Melsec; TCP/IP; SMTP; FTP
Power Consumption: 24 VDC±10%, 600 mA maximum
Material: Die-cast aluminum housing
Dimensions: 134.4 mm (5.29 in)×124.1 mm (4.88 in)×61.4 mm (2.42 in) with lens cover installed
Connector type: M12 Ethernet, M12 Power/IO
IP Rating: IP 67 with lens cover on
   While the specific specifications are provided for the vision camera 510 above, these are merely exemplary embodiments and that the present system may utilize any appropriate configuration of a vision camera 510 or any inspection device for that matter. Further, depending upon the application of the present system, specific capabilities of the vision camera 510 may be required. These various configurations may be contemplated by the present disclosure.

A vision illuminator 520 may aid in the photographing of the unthreaded fasteners 120 by providing light to illuminate the edges and contrasting surfaces of the unthreaded fasteners 120. This may allow for a more accurate image and inspection of said image. The vision illuminator 520 may be any appropriate light source, including, but not limited to, a dark field ring light, a black light, an incandescent light bulb, LED, etc. Further, any kind of image enhancing device may be utilized with the present disclosure. The present teachings are not limited to just that described herein. The system may also contemplate a computing device and/or software program that may provide enhancements to the images taken—such as after the images are taken. In some embodiments, the images may not be enhanced at all—the vision camera 510 may have a sufficient resolution that such enhancements are unnecessary. In other embodiments, an image enhancement, such as those described herein, may be utilized on all of the images, some of the images (such as ones that do not meet a specific threshold) or on a random or select number of the images.

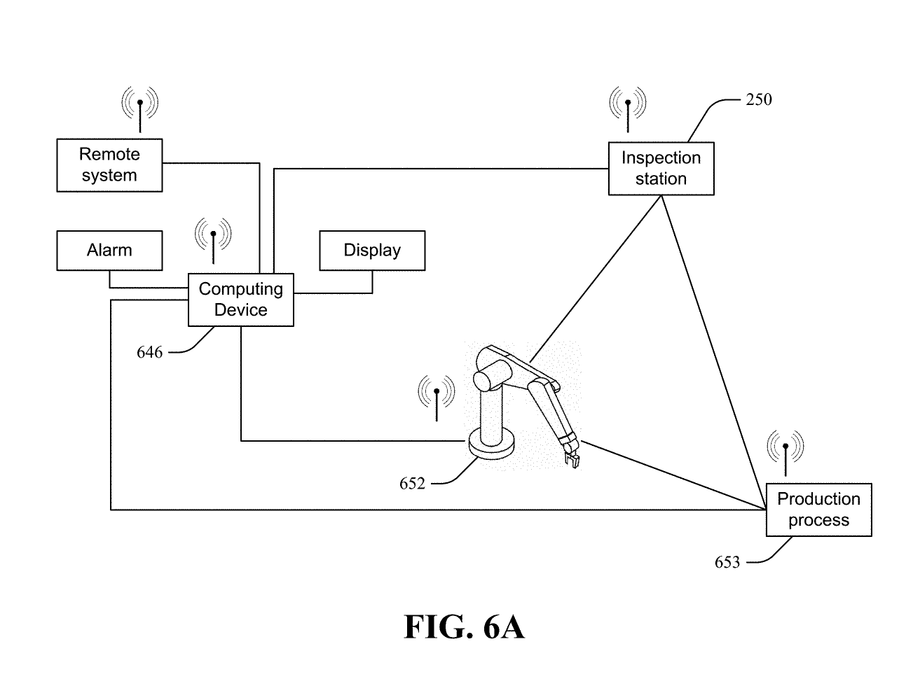

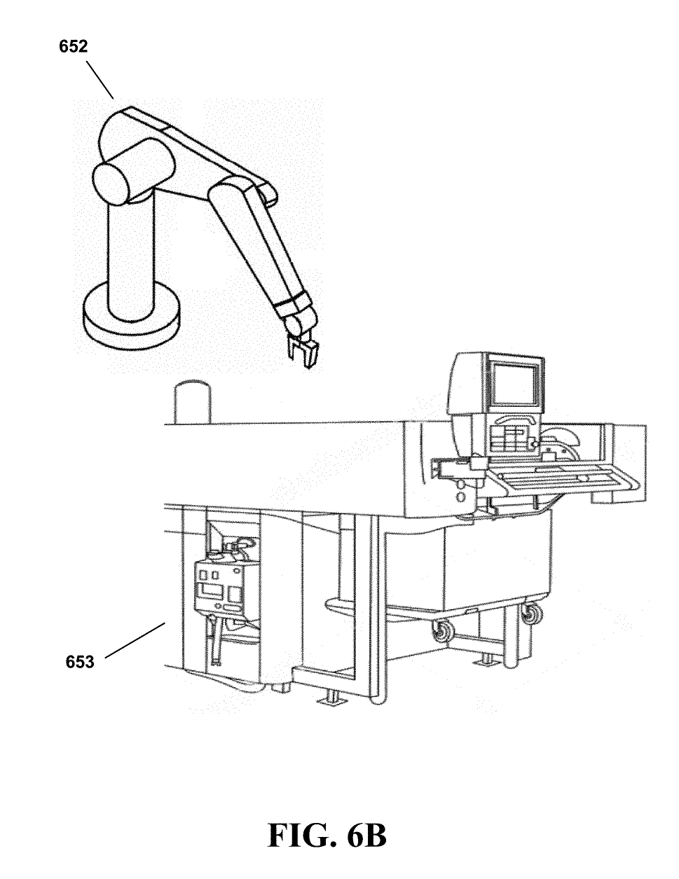

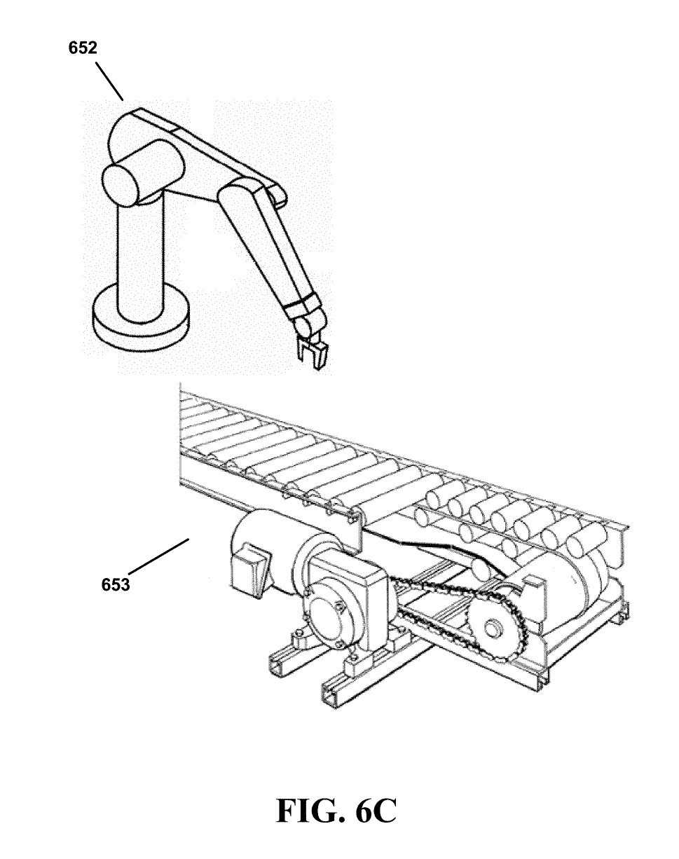

The images may be transferred to a processor or computing device 646 of any appropriate type and configuration for analysis, as shown in FIG. 6A. The computing device 646 may run a vision software program that may analyze images and other pertinent information about the fasteners 110. The computing device 646 may also be utilized to enhance the images. The computing device 646 may further be utilized as a communication hub between the various components of the system. The computing device 646 may allow for communication to and from the various components as further described hereafter. The computing device 646 may comprise the following specifications:
Intel® Pentium® 4 processor running at 2 GHz (or equivalent)
1 GB of available RAM
2 GB of available hard-disk space
Video card capable of displaying 2024×768 resolution at 24-bit color depth (the DPI Display setting must be set to 96 DPI)
Network Interface Card (at least 100 Mbps) for connecting to an In-Sight vision system Recommended Specs
Intel Core™ i7 processor running at 2.7 GHz (or equivalent)
4 GB of available RAM
2.5 GB of available hard-disk space
Video card capable of displaying 1920×1080 resolution at 32-bit color depth (the DPI Display setting must be set to 96 DPI)
Gigabit Network Interface Card
   Operating system requirements may include:
Microsoft® Windows® 10 Professional (64-bit)
Microsoft® Windows® 7 Professional, Service Pack 1 (64-bit)
Microsoft Windows Server 2008 R2, Service Pack 1 (64-bit)
   The software program on the computing device 646 may be programmed with specifications for the dimensions, including the size, shape, allowable tolerances, or other characteristics of the fasteners for use to determine appropriate acceptance or rejection criteria. Further, the software program may be programmed with algorithms used to determine whether a fastener 110 falls within an acceptable range of dimensions, i.e., within the allowable tolerances of the workpiece. The software program may, by way of a non-limiting example, analyze pixel patterns using these programmed algorithms to check for non-conforming workpieces—this is particularly useful to determine if there are any surface imperfections in the fastener 110. Additionally, the software program may serve to provide an enlarged visual representation of the fastener 110 in question during analysis by the vision camera 510, e.g., as shown on the computing device 646 in FIG. 6A. The computing device 646 may be hardwired or wirelessly connected to the system. The computing device 646 may be remote from the system, such as in an office of a supervisor, in a location offsite or even on a portable computing device such as a laptop, tablet or smartphone. Further, the computing device 646 could utilize a software program or app that could be accessible by any computing device from any location or multiple locations. This may allow the system to be managed from a remote location. By way of a non-limiting example, a supervisor, quality control engineering or manufacturing engineer may monitor the quality of the workpieces during the processing thereof or the production process itself. The system 652 may, for example, allow such person to modify the system should the workpieces begin to fall out of acceptable tolerances, shut down the system, modify the production process 653, change tooling, perform quality checks (random or planned), monitor the production process, or take any other appropriate action based upon the information provided to such person.

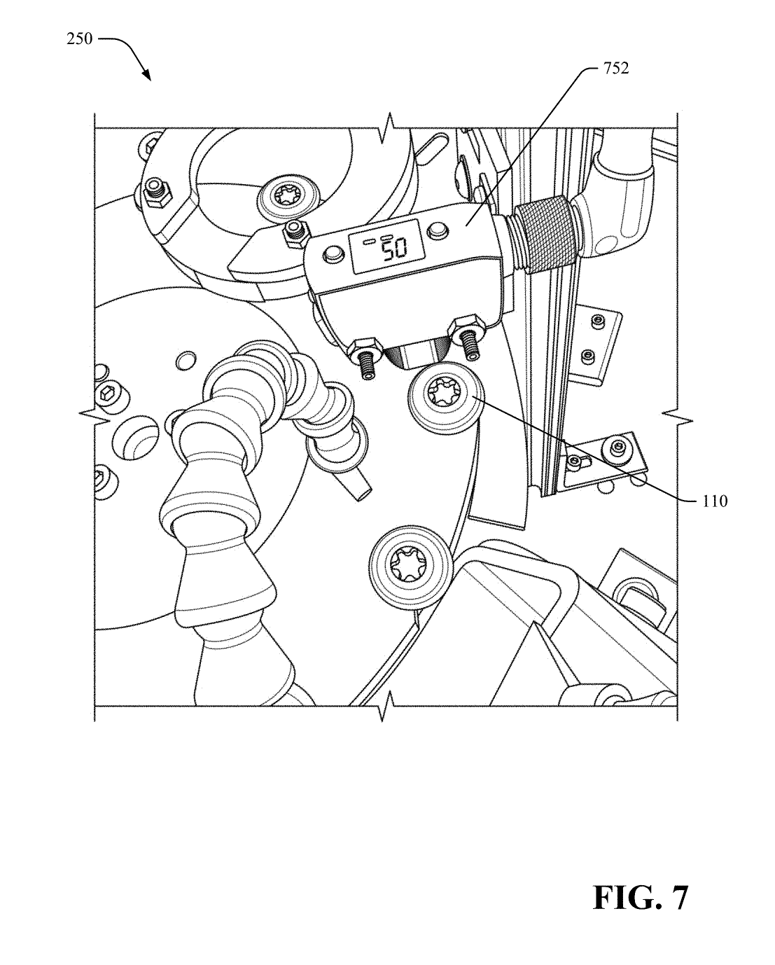

The primary inspection station 250 may also include a measuring device 752, including, without limitation a laser distance sensor as shown in FIG. 7, a 3-D measurement system, a visual measurement process and/or device or any combination of the foregoing. More specifically, the measuring device 752 may include, without limitation, a laser-scanning device, a coordinate measuring machine, laser radar, infrared laser, or the like. However, the present teachings are not limited to the foregoing. Any kind of measuring device and/or sensor may be utilized. The measuring device 752 may check for a specific or set of specific attributes of the workpieces. For example, the measuring device 752 may check the three-dimensional attributes of the fasteners 110, e.g., the presence and dimensions of recesses, head size, thread dimensions, width, height, etc. By way of a further non limiting example, the measuring device 752 may measure the height of the fasteners 110, the width of the head of the fasteners 110, the depth of the tool engagement portion 114. The present teachings, however, are not limited to the foregoing dimensional checks. Any dimensional check of a workpiece is contemplated by this disclosure. Information gathered from the measuring device 752 may be analyzed on the computing device 646 and provide information about the production/manufacturing process itself and/or the tooling utilized therein or the workpieces themselves. Moreover, other information may be obtained utilizing additional sensors (such as by way of a non-limiting example, speedometers, accelerometers, cameras, lasers, infra-red sensors, bar codes and readers, RFID, near-field communication and the like) positioned along the production path. The information from the sensors and/or measuring device 752 may include the operational speed of the applicable machines (e.g., rotation speed, linear speed, etc.), the travel time of the workpieces along the production path, and/or the position of the workpiece at a pre-defined moment along the production path. Further still, quality gauges of any configuration may be utilized. These quality gauges may measure a specific dimension to determine if it is within a defined tolerance or a specific feature of the workpiece to determine if it meets a predetermined specification. Any combination of such information may be utilized.

By way of a non-limiting example, information gathered from the measuring device 752 may be analyzed on the computing device 646 and may provide information about the tools being used to form the three-dimensional attributes of the fasteners 110, e.g., issues with a punch tool. These may include tools not in proper working order, tools in need of repair, tools that are worn out, etc. These deficient tools may cause the workpieces to fall out of the allowed tolerance ranges. The dimensional measurements may be of any appropriate attribute or set of attributes of workpieces. Identifying the tooling from the manufacturing portion of the system that are or may be deficient may allow action to be taken on the tooling before workpieces become non-compliant. This action may include replacing the tooling (or a portion thereof, such as a bit), making adjustments to the tooling to account for the deficiency (e.g., accounting for the tool becoming worn), shutting down the system, shutting down a portion of the system, or moving the process to a different component or tooling so that the deficient tooling may be fixed or replaced. This later alternative may allow the entire system to remain operating despite the tooling be deficient. Further, the information obtained may be communicated to the computing device 646. This information may be stored for further processing, processed as part of a quality control system, utilized to modify the production process or a portion thereof (e.g., automatically change or alter the tooling), notify a responsible person, automatically shut down production, slow production, or any combination of such. The information may be communicated from the measuring device 752 (or any component of the system) to the computing device 646 and back to the measuring device 752 or to any component of the system such as the tooling.

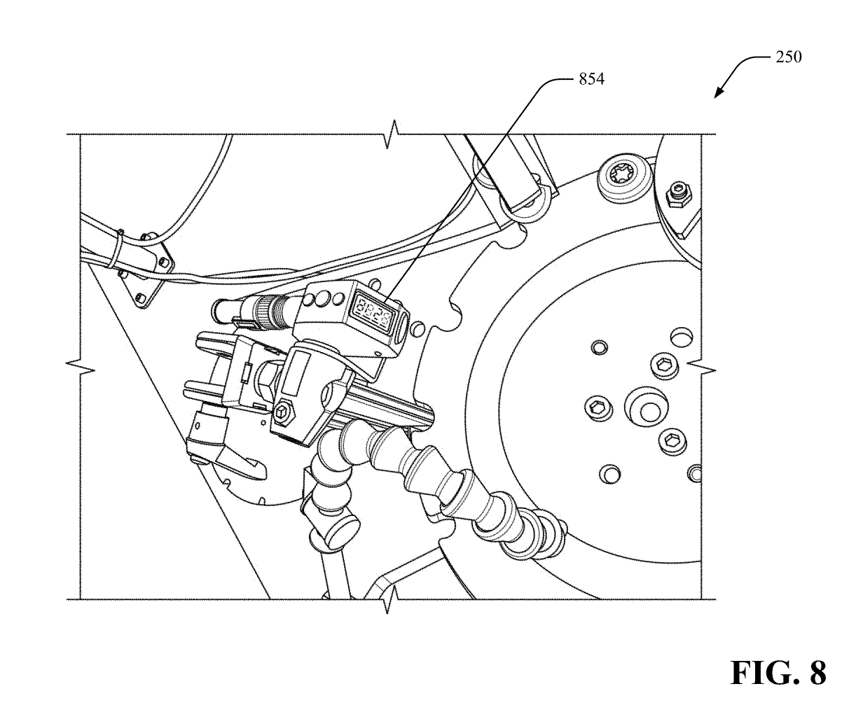

The primary inspection station 250 may also include a laser-timing sensor 854, as shown in FIG. 8. The laser-timing sensor 854 may determine the location of a fastener 110 on the primary inspection station 250 and/or the rate at which it moves along the system (e.g., the production process). The laser-timing sensor 854 may be any appropriate type of laser, including, but not limited to, an infrared laser. Working in conjunction with the software program, the laser-timing sensor 854 may aid in determining proper positioning of the fastener 110 to take an image for analysis—such as described above. Further, the laser-timing sensor 854 may allow for the programming to properly center and align the fastener 110 under the appropriate inspection tools, e.g., the vision camera 510, the vision illuminator 520, the laser distance sensor 752, quality gauges, etc. Additionally, the laser-timing sensor 854 may help to align the motors of the primary feed rail 244 to feed the fasteners 110 onto the primary inspection station 250 at the appropriate speed and at the appropriate position. The primary inspection station 250 may also include a motor encoder to determine proper or preferred positioning of parts and/or workpieces. Moreover, the primary inspection station 250 may also determine if any portion of the system involved with moving the workpieces (e.g., the production path) is operating in accordance with the predefined specifications.

In other embodiments, the primary inspection station 250 may also include an eddy current testing (ECT) system for identifying cracks and other non-conformities in the fasteners 110. In an aspect, the system may utilize a single-element ECT probe, a pulsed eddy current, an eddy current array or a combination of two or more thereof. The use of ECT allows for faster inspections with less operator dependence. Also, a 3-D measurement or visual measurement process and/or device may be utilized for similar purposes. This may allow for detection of visually impossible to detect workpiece, pits, voids, etc. The primary inspection station 250 may include any combination of inspection gauges and systems. The present system is not limited to a specific type or configuration of inspection systems. The inspection system may be utilized to determine the status of the workpiece, which may be utilized as an inspection of the workpieces or may be utilized to determine the status of the tooling associated with the production of the workpiece, status of the machines moving the workpieces along the production path, the inspection tools, and the like. For example, the inspection system may be utilized to identify a trend of a specific tool causing workpieces to come out of tolerance. This information may be communicated to the computing device 646 and be utilized to fix, change, or otherwise modify the process to account for the tooling before the workpieces actually come out of tolerance. This may prevent the system from producing non-compliant parts and/or from having to be shut down for repairs or tooling changes.

In at least one embodiment, the laser distance sensor 752 may include a ⅔-inch CCD with global shutter model#5705, manufactured by Cognex. This system may produce an image with a resolution of about 2448×2048 with 16 full frames per second. The present teachings, however, are not limited to this configuration. The laser distance sensor 752 may be of any appropriate configuration or type.

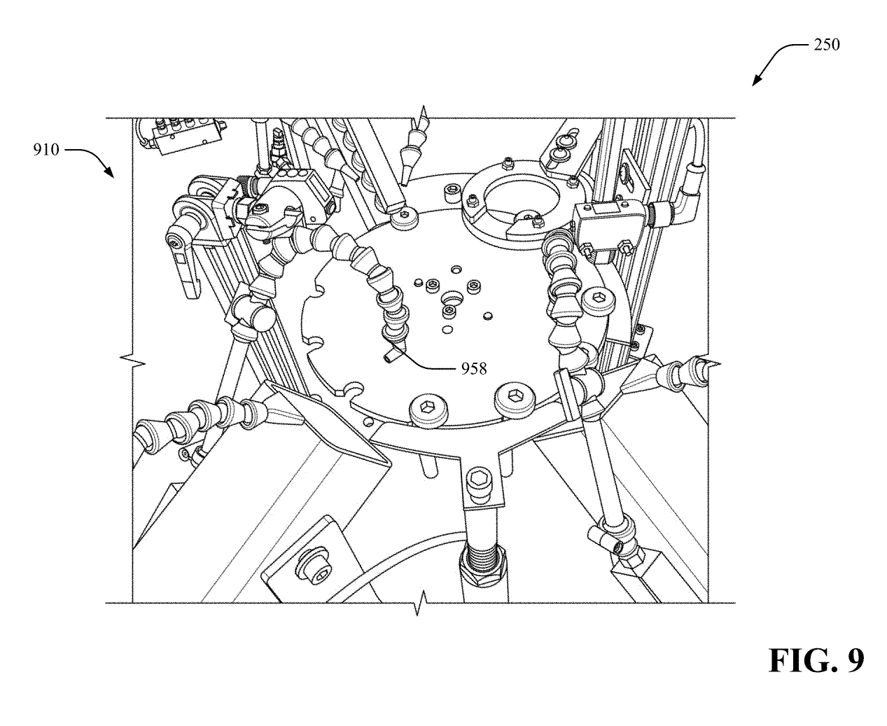

The primary inspection station 250 may also include a removal mechanism 910 of any appropriate embodiment. For example, the removal mechanism as shown in FIG. 9 may be utilized. The removal mechanism 910 may be a component capable of repositioning workpieces being processed, including, without limitation, the fasteners 110—such as to remove them from the system. In an embodiment, the removal mechanism 910 may include pneumatic lines 958, i.e., flexible hollow tubes configured to transport pressurized air that is able to blow fasteners 110 from the inspection station.

While the sorting/manufacturing system 200 is operating, the tools of the inspection station 250 may provide information to the software through the computing device 646 that, upon analysis, is determined to indicate a non-conforming fastener 160. The software may then activate the pneumatic lines 958 that then blow the non-conforming fastener 160 from the inspection station and into a primary scrap container 259. Similarly, if the information provided to the software indicates that the fastener 150 is compliant, the pneumatic lines 958 may apply pressurized air to the fastener 150 so that it maintains its position on the inspection station to continue along to the next processing station. The pneumatic lines 958 may function in any appropriate manner. In one embodiment, the pneumatic lines 958 may contain a solenoid energized by a controller that actuates under specified conditions, allowing or restricting airflow as necessary for the appropriate function.

Further, the removal mechanism 910 may be any other appropriate component capable or removing and/or maintaining the position of a workpiece, e.g., a magnet, a flipper, a vacuum, air knife, etc. The removal mechanism 910 of the present teaching may move or otherwise allow movement of a predetermined workpiece such as to sort the workpieces, e.g., compliant, non-compliant. The system may also sort the workpieces based on any other parameters, shape, size, head type, etc. While the above description discloses removing non-compliant workpieces, the opposite may occur, i.e., compliant workpieces are removed or moved while non-compliant workpieces remain. Further, the removal mechanism 910 may move both compliant and non-compliant workpieces from one location to another. The present disclosure contemplates any combination of the foregoing.

In a non-limiting example, the conforming fasteners 150 may be transported by a first conveyer 256 into a thread roll feeder bowl 260 as shown in FIG. 2. The thread roll feeder bowl 260 may orientate and align each unthreaded fastener 150 from an initial irregular pile in a commonly-oriented fashion, feeding into a single line for transport on a thread roll feed rail 264. The thread roll feed rail 264 may transport unthreaded fasteners 150 from the thread roll feeder bowl 260 into a thread roller machine 270. The thread roller machine 270 may be any appropriate machine that can add and/or carve threads into the unthreaded fasteners 150. After the fasteners have been threaded, they may be expelled from the thread roller machine 270 onto a second conveyer 276. While the thread roller machine 270 is described, the present teachings may include any kind of processing device, e.g., a lathe, drill, CNC machine, etc.

The threaded fasteners 170 may be transported by the second conveyer 176 into a secondary feeder bowl 280. The secondary feeder bowl 280 may orientate and align each fastener 110 from an initial irregular pile in a commonly-oriented fashion, feeding into a single line for transport on a secondary feed rail 284. The secondary feed rail 284 may transport threaded fasteners 170 from the secondary feeder bowl 280 onto a secondary inspection unit 292 of a secondary inspection station 290.

The secondary inspection station 290 may contain all or some of the tools as the primary inspection station 250, including, but not limited to a vision camera, a vision illuminator, a laser distance sensor, a laser timing sensor, 3-D measurement or visual measurement device and/or any combination of same. These tools may analyze the threaded fasteners 170 in a similar fashion to the analysis of the unthreaded fasteners at the primary inspection station 250. Threaded fasteners 170 that are non-conforming may be relocated by a removal mechanism to a secondary scrap container 299 and conforming threaded fasteners 190 may be relocated by a removal mechanism to a finished product container 298. The conforming threaded fasteners 190 in the finished product container 298 may be used in further manufacture or prepared for sale to customers. Alternatively, the conforming threaded fasteners 190 may continue down the process line to an additional component for further manufacture.

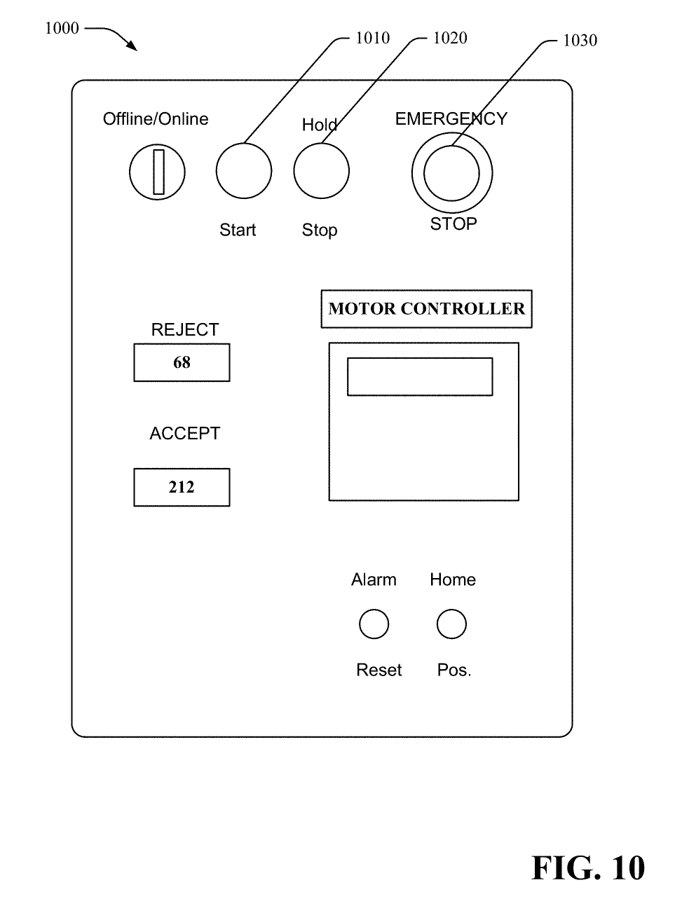

The sorting/manufacturing system 200 may be controlled by a control panel 1000, as shown in FIG. 10. The control panel 1000 may serve as a diagnostic control for the operator of the sorting/manufacturing system 200. The control panel 1000 may include buttons for manual control, including start 1010, stop 1020, and emergency stop 1030, statistical information gathering, data analysis, productivity/Overall Equipment Effectiveness (OEE) information gathering, and machine setup recipes for quick change. The control panel 1000 may also include screens that show counts of non-conforming and conforming products, speeds, etc. The control panel 1000 may be located in any appropriate position along the sorting/manufacturing system 200 and related process lines. In an embodiment, the control panel 1000 may be hard wired or wirelessly connected to the sorting/manufacturing system 200. Further, the control panel 1000 may be remote from the rest of the system. In a non-limiting, the control panel 1000 may be part of or in direct communication with the computing device 646. For example, the control panel 1000 may be included in the computing device 646 such as a software program or app. The control panel 1000 may allow a user to operate the system remotely. The control panel 1000 may be included with a remote computing device, e.g., a desktop computer, laptop, notebook, tablet, smartphone or the like. In some embodiments, any of the afore-mentioned devices may be utilized in conjunction with the control panel 1000. Such computing devices 646 may communicate directly with the control panel 1000. The computing devices 646 may act as a surrogate device for the control panel 1000. In these embodiments, a duplicate of the control panel 1000 may be displayed on the computing device 646. This may allow a user to utilize the remote computing device in conjunction with the control panel 1000. This may allow for remote operation of the present system.

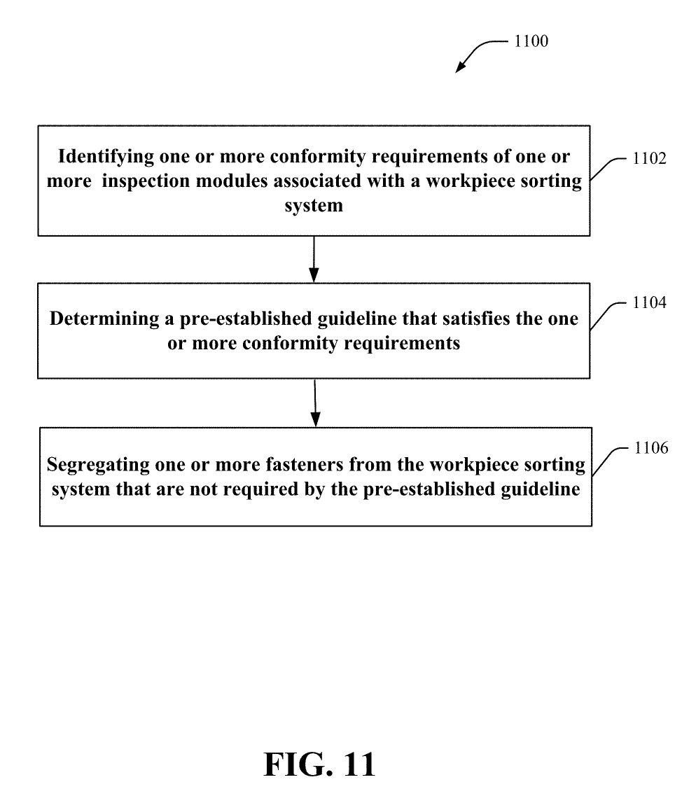

FIG. 11 illustrates a flow diagram of an example, non-limiting computer-implemented method 1100 that segregates one or more fasteners in accordance with one or more embodiments described herein. Repetitive description of like elements employed in other embodiments described herein is omitted for sake of brevity. At 1102, a system 200 comprising a processor can identify one or more one or more conformity requirements of one or more inspection modules associated with the sorting system. At 1104, a pre-established guideline that satisfies the one or more conformity requirements can be determined by the system 200. At 1106, one or more workpieces from the sorting system may be segregated by the system 200, in response to computing device 646 falling outside the pre-established guideline and thus deemed not currently necessary to achieve present operational needs or goals of the sorting system.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

The present disclosure is not limited to the configuration described above. In an embodiment, the present disclosure may include additional feeder bowls and inspection stations. In an embodiment, the present disclosure may include a single feeder bowl and inspection station. In an embodiment, the present disclosure may only inspect the fasteners after they have been threaded. In an embodiment, the fasteners may travel through multiple feeder bowls and inspection stations as additional quality control mechanisms. In an embodiment, the present disclosure may include a parts washer, a dunk tank, a centrifuge or a combination of two or more of these components, which may process the workpieces further. In an embodiment, a rejected fastener may be cleaned and returned to the manufacturing line for further inspection. In an aspect when the rejected fastener merely had a piece of a dirt or other nonconformity, the cleaning process will allow the fastener to rejoin the manufacturing line and save the cost of lost fasteners that merely dirty as opposed to misshaped, cracked, etc.

Further, the various components of the present disclosure may have a standard or non-standard set up. For example, the present disclosure components may have plug and play tooling fixtures, the components may be rearranged, removed, repaired, etc., by individual components or multiple components at a time. In an embodiment, the machines and/or tooling of a similar size, category, and/or purpose may be grouped together. In an embodiment, the machines of a similar purpose may be spaced apart for repeat testing throughout the manufacturing line. The present teachings may include any kind of manufacturing machines, e.g., lathes, drills, CNC machines, etc.

Further, in some embodiments, the system may be set up using motors (such as electric motors) pneumatic devices, hydraulic devices, or magnetic devices as positioners to reduce setup time and ease adjustment work. In one exemplary embodiment, workpieces may be inspected and if a dimensional trend is identified and associated with a specific tool, the positioners may move the tool to replace it, reposition the tool within the production process to account for something like wear, or move the tool to adjust the dimensions under which it operates. These adjustments may allow the system to remain operational and to account for workpieces that would otherwise fall out of tolerance if the tooling had not been adjusted, e.g., rotating bits, motor solenoid, table, and electric motor, etc. By way of a further non-limiting example, if the depth of the tool engagement portion 114 is becoming shallower as determined by the primary (or secondary) inspection system, the tooling used to create the tool engagement portion 114 may be adjusted to process a deeper tool engagement portion 114. This may allow the system to account for the wearing of the tooling for the tool engagement portion 114. Further still, the tool may be replaced with another tool so ensure that the tool engagement portion 114 is at the specified depth. In this embodiment, multiple tools for machining the tool engagement portion 114 may be positioned on a single cartridge head. The cartridge head may be rotated to replace the worn tool with a new tool. The worn tools may be replaced at a future point. This may prevent the system from being stopped or down. It should be understood that the afore-mentioned tool replacement is merely exemplary. The present teachings contemplate any of the tooling in the production process being replaced or modified (adjusted) such as through a non-manual process.

Moreover, the system may allow for different scalability of its components. For example, components may be run at one speed or individual components may be run at different speeds to match the production speed of the constrained production process. The system may identify the specific workpiece being worked on and adjust the speed (or any other factor) of the system based upon the specification of the specific workpiece. By way of a non-limiting example, a first workpiece may be able to proceed through the entire process at a greater speed than a second piece because the first piece has greater tolerance levels than the second piece.

Further, there may be one initial input into the system at a start of the processing line, or there may be two or more input points in the sorting system to reduce the overall costs of the system and improve the efficiencies of the work cell. Likewise, there may be one endpoint of the sorting system or multiple endpoints throughout the system. In some embodiments, the endpoints allow the system to sort one sized workpieces into one endpoint, and a second sized workpieces into a different endpoint, etc. Furthermore, there may be one or multiple ejection paths for non-conforming workpieces to feed multiple downstream workstations or group product into similar characteristics or attributes. In one embodiment, the system may contain a single table with multiple ejection chutes. For example, this may allow the workpieces to receive different processing. A pre-selected number of workpieces may receive a finishing process while others do not.

The process line for manufacturing fasteners or other workpieces requires speedy detection of any non-conforming fasteners. The system may detect various non-conforming attributes of a fastener in a time-efficient process. The system provides an inspection method employing a variety of tools and techniques in the inspection station. The inspection tools, i.e., the camera, illuminator, and lasers, of the sorting system may evaluate the dimensions of a fastener head and unitary threaded or unthreaded portions of a fastener body. The tools may analyze the outer diameter of the fastener head and/or the fastener body. The tools may determine the pitch of the threads on a threaded fastener. The software program may compare these dimensions to those preprogrammed predetermined standards and instruct the removal of fasteners that do not meet these standards.

Further, the inspection tools may analyze the surface of a fastener to determine if there are any non-conforming attributes, e.g., a torque recess in the head, torque to head centrality, shank centered on head, torque recess centered on head, surface defects in the head or the body, missing or misaligned threads, cracks in the head and/or the body of the fastener, excess material on a fastener, check for concentricity of the parts, check for broken/chipped torque wing, etc. The software program (such as through the computing device 646) can compare these non-conformities to those preprogrammed predetermined standards and instruct the removal of fasteners with non-conformities that would impact consumer and/or manufacturer's use. The analysis of the dimensions of a fastener may involve preset standards, preset algorithms, pixel analysis, etc.

The inspection tools can also check the quality of the system components and materials used in the system, e.g., tool life predictions, measurements, adjustments, defects in components, including deterioration and wear and tear on components, washer water, machine fluid levels and pH values, etc. This statistical process control (SPC) data may be communicated to other systems, such as into software, Plex, graphics, charts, word processing documents, spreadsheets, etc., and allow for individuals, such as supervisors or engineers, to see deficient areas in the system through various means, including text messages, e-mails, print-outs, verbal announcements, alarms, or any other appropriate means. This may also include visual lights, LED monitors, and to other machine logic controllers. The data can allow an individual or the system itself to change out defective components, flush liquids, add more solvents, etc. as required for operation of the sorting system. The data can also provide additional information for documenting standard operating procedures (SOP) and/or allow the operators to easily update and note changes in the same.

The system may also automatically and/or manually complete tooling inspections for its components to detect various issues, including, but not limited to, in machine and off part dimensional parameters, quantity trackers for predictive tool life, and creating feedback and control loops and establish separate parameters for the components. By collecting data from these inspections, an operator is able to stop the component or entire system, and repair and/or replace the component at issue. Further, this data may allow a user to alter and/or inspect the internal machine dimensions of the components prior to running the system—it may allow the operator to control the entire manufacturing/inspection process. For example, the sorting system may be quickly changed over to produce/inspect different workpieces. These tooling inspections allow for “lights out” running with minimal human supervision. This allows for a more cost effective manufacturing process. Further, the data results indicating tool life issues allow for quick identification of components at issue. The set-up of the system allows for the easy replacement or repair of an individual component.

Implementation of system 200 may include inspections allowing the automatic calculation of cell process performance, Overall Equipment Effectiveness (OEE), etc. These calculations are completed within the system gathering statistics of parts produced and rejected over the period of time the machine is running. These results may help the operators know the performance of the system and can make adjustments as needed to improve these metrics.

Previous methods of quality control had a rejection rate of approximately 0.02%. The present system described above may reduce the rejection rate by 75%. Further, in addition to providing an improved rejection rate, the system may provide improved efficiency through use of a high-speed camera, high speed lasers, and a high speed processor for analysis. Additionally, the dimensions and algorithms used for analysis may be updated and edited in an efficient method through use of a computer program versus retooling line equipment, etc.

The various components of the sorting system may be made from any material known to those skilled in the art, including, but not limited to, metals, alloys, ceramics, polymers, wood, etc. In addition, it is understood that the foregoing description and drawings merely explain and illustrate the invention, and the present teachings are not limited thereto, except as those skilled in the art who have the present disclosure before them will be able to make modifications and variations therein without departing from the scope of the invention.

Further, the system may be utilized to control the manufacturing process in its entirety. Further still, the system may control a portion of the manufacturing process. In a non-limiting example, the system can control the manufacturing process of a workpiece from start to finish. The system allows for each of the parts to be inspected at any appropriate point along the process, such as at an initial stage, once the threads have been added, and once the head has been formed. Further still, the process can be modified automatically. The tooling may be changed after a set period of operations, after a set time or it may be inspected such that when it shows a predetermined amount of wear, it may be replaced or recalibrated.

Through its feedback loops, the self-regulating system can provide instantaneous reports to the line supervisors, engineers, and the like. The delivery of feedback via text message, email or other forms of communication may allow for efficient response of the workers. In some aspects, the delivery of feedback will be coupled with an automatic adjustment to a machine without human instruction or adjustments may be made with human intervention. In some aspects, this may involve adjusting the parameters or settings on the machine, e.g., such as speed or recalibration. In other aspects, this may involve retooling a machine. In an aspect, it may involve shutting down the machine to allow for repair or maintenance, such as cleaning. In an aspect, a self-regulating machine may be able to self-repair or maintain, e.g., by lubricating, cleaning, etc. In an aspect, it may involve the machine starting up and/or speeding up. The system may control the production equipment, allowing the system to run with little to no human interaction and/or instruction.

The design of the system and its machines allows for faster inspections with less operator dependence. This independence of the system allows for a more efficient manner—producing more conforming fasteners in a shorter period with limited operator instruction and interaction. The system allows for an improved process resulting in reduced manpower required to operate the components, and an increased output of conforming products—both of which ultimately result in a cost-savings to the manufacturer.

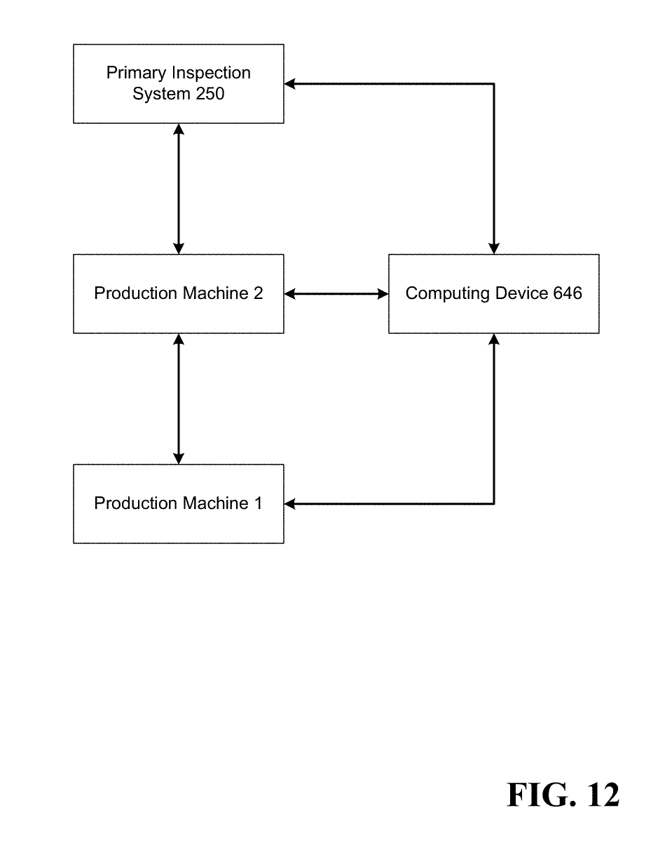

As depicted in FIG. 12, each of the components of the system may communicate with one another, communicate with a specific component, and communicate through the computing device or any combination of the foregoing. FIG. 12 is merely an exemplary embodiment and is solely depicted from the sake of brevity. However, one skilled in the art will understand that any appropriate communication link may be utilized without departing from the present teachings. As shown, the primary inspection system 250 may communicate with the computing device 646. This communication may be hard-wired or wirelessly accomplished. The communication may be utilized for any known reason, such as by way of a non-limiting example, to notify a user of an issue related to the inspection of workpieces, to allow adjustment of the inspection system based on information received and processed by the computing device 646 or the like. Similarly, the various production machines may communicate directly with the computing device 646 and/or communicate with the inspection system or with the other production machines. The communication may be hardwired or wireless. As can be appreciated, any set of communication amongst and between the various components of the system may be accomplished. The communication may allow for the autonomy of the entire system. It may allow for adjustments to be made to any part of the system such as without human intervention, including, without limitation changing tooling because it has worn, adjusting the tooling because a predefined specification is reaching the limits of the tolerance and any other contemplated circumstance. In addition, or in the alternative, it may also notify a user who can then take any appropriate action in relation to any of the components of the system. The communication between and amongst the various components may provide notification to a user of a specific situation, e.g., a certain number of workpieces are non-compliant. The communication link may be the portion that ties the components together to work in unison as an automated system. As noted above, the computing device 646 may be the catalyst for the communication link between and amongst the other components of the system.

Although the embodiments of the present teachings have been illustrated in the accompanying drawings and described in the foregoing detailed description, it is to be understood that the present teachings are not to be limited to just the embodiments disclosed, but that the teachings described herein are capable of numerous rearrangements, modifications and substitutions.

What is claimed is:

1. A production system comprising:
a first production processing machine capable of processing a workpiece;
a second production processing machine capable of processing the workpiece;
a workpiece transfer device, the workpiece transfer device moving the workpiece from the first production processing machine to the second production processing machine;
an inspection device identifying whether the workpiece meets at least one specification of the workpiece; and
a computing device in communication with the inspection device notifying a user whether the workpiece is compliant with the at least one specification;
wherein the computing device is operative communication with either or both of the first production processing machine and the second production processing machine whereby the computing device alters operation of either or both of the first and second production processing machines.

2. The production system of claim 1, wherein the inspection device comprises at least one vision camera in communication with the computing device.

3. The production system of claim 1, wherein the workpiece transfer device comprises:
at least one feeding unit; and
at least one conveyor unit wherein the at least one feeding unit orients the workpiece into the at least one conveyor unit.

4. The production system of claim 3, wherein the at least one conveyor unit transfers the workpiece from the at least one feeding unit onto the inspection device.

5. The production system of claim 1, wherein the inspection device comprises a measurement unit device, wherein the measurement unit inspects a dimensional conformity of the workpiece.

6. The production system of claim 1, wherein the inspection device comprises at least one selected from the group consisting of a laser-timing sensor, an eddy current testing probe, a pulsed eddy current, and an eddy current array.

7. The production system of claim 1, wherein the computing device is remote from the first and second production processing machines.

8. The production system of claim 7, wherein the computing device is in wireless communication with the first and second production processing machines and the inspection device.

9. The production system of claim 1, wherein the inspection device comprises a sensor determining required parameters selected from the group consisting of presence, dimensions of recesses, head size, thread dimensions, width, and height.

10. The production system of claim 1, wherein the workpiece transfer device comprises a removal mechanism selected from the group consisting of magnet, a flipper, a vacuum, and air knife.

11. The production system of claim 1, wherein the workpiece transfer device comprises a pneumatic line with a solenoid.

12. The production system of claim 1, wherein the computing device alters operation of either or both of the first and second production processing machines comprises altering at least one tool of either of the first and second production processing machines.

13. The production system of claim 12, wherein altering the at least one tool comprises at least one of replacing the at least one tool with a second tool, modifying an operation process of the at least one tool, and modifying the at least one tool.

14. The production system of claim 1, wherein the computing device generates date from the inspection device, whereby the data comprises statistical process control (SPC), productivity, Overall Equipment Effectiveness (OEE), and machine setup recipes for quick change.

15. The production system of claim 1, wherein the first production processing machine is different from the second production processing machine.

16. The production system of claim 1, wherein the workpiece transfer device moves the workpiece from the first or second production processing machine to the inspection device.

17. The production system of claim 1, wherein the workpiece transfer device is in communication with the computing device to remove the workpiece from the workpiece transfer device when the workpiece fails to meet the at least one specification.

18. A computer-implemented method of analyzing workpieces to determine if they meet pre-established guidelines for conformity, the method comprising:
identifying one or more conformity requirements of one or more inspection modules associated with a production system by a device operatively coupled to a processor;
determining a pre-established guideline that satisfies the one or more conformity requirements by the device;
executing operation associated with the one or more workpieces that are not required by the pre-established guideline by the device;
analyzing data associated with the operation associated with the one or more workpieces; and
executing one or more actions based on the analysis of the operation associated with the one or more workpieces.

19. The computer-implemented method of claim 18, further comprising:
updating the pre-established guideline based on changes in the one or more conformity requirements by the device.

20. The computer-implemented method of claim 19, wherein the executing one or more actions comprises modifying at least one tool of the production system.

21. A high-speed production system comprising:
first and second production processing machines applying a specified production task on a workpiece;
a workpiece transfer device, the workpiece transfer device transferring the workpiece from the first production processing machine to the second production processing machine;
an inspection device identifying whether the workpiece meets at least one specification; and
a computing device in operative communication with the inspection device notifying a user whether the workpiece is compliant with the at least one specification;
wherein the computing device is in operative communication with the inspection device and the first and second production processing machines whereby the computing device alters operation of either or both of the first and second production processing machines.

22. The high-speed production system of claim 21, wherein the computing device is a communication link between all of the inspection device and the first and second production processing machines.

23. The high-speed production system of claim 22, wherein operation the inspection device adjusts operation of the first and second production processing machines through the communication link.

24. The high-speed production system of claim 21, wherein the workpiece comprises a fastener.

25. A production process comprising:
identifying one or more conformity requirements of one or more inspection modules associated with a production system;
determining a pre-established guideline that satisfies the one or more conformity requirements;
executing operation associated with one or more workpieces that are not required by the pre-established guideline;
analyzing data associated with the operation associated with the one or more workpieces; and
executing one or more actions based on the analysis of the operation associated with the one or more workpieces.
